(19) United States
(12) Patent Application Publication
(10) Pub. No.: US 2020/0279285 A1
(43) Pub. Date: Sep. 3, 2020

(54) REFERRAL SYSTEM AND METHOD

(71) Applicant: WorkLlama, LLC, Atlanta, GA (US)

(72) Inventors: Sudhakar Maruvada, Duluth, GA (US); Saleemuddin Khaja, Marietta, GA (US); Krishna Jagannadha Vedula, Suwanee, GA (US)

(21) Appl. No.: 16/805,077

(22) Filed: Feb. 28, 2020

Related U.S. Application Data
(60) Provisional application No. 62/812,542, filed on Mar. 1, 2019.

(51) Int. Cl. G06Q 30/02; G06Q 10/10; G06Q 50/00

(52) U.S. Cl. CPC G06Q 30/0214; G06Q 50/01; G06Q 10/1053

(57) ABSTRACT

A computer-implemented method, computer program product and computing system for defining a listing for an item; and defining a multi-level referral program for the listing.

### RELATED APPLICATION(S)

This application claims the benefit of U.S. Provisional Application No. 62/812,542, filed on 1 Mar. 2019, the entire contents of which are incorporated herein by reference.

### TECHNICAL FIELD

This disclosure relates to referral systems and, more particularly, to multi-level referral systems.

### BACKGROUND

Generally speaking, referrals are often the best way to effectuate a response. For example, referrals are the largest source of candidates for filling job openings (both in terms of volume and quality). Accordingly, when a company has to hire someone to fill an open position, that open position is most often filled by a referral from e.g., an existing employee of the company or a person external to the company. Further, referrals play a significant role in steering/directing customers towards businesses. For example, people will often say to someone “I am looking for some good Italian food in Detroit . . . where should I go?” Or “I am looking for someone reliable that can paint my house . . . do you have any suggestions?”

And unfortunately, unless you are a professional (such as a recruiter/headhunter), the ability for someone to be compensated for making such referrals is greatly limited.

### SUMMARY OF DISCLOSURE

In one implementation, a computer-implemented method is executed on a computing device and includes: defining a listing for an item; and defining a multi-level referral program for the listing.

One or more of the following features may be included. The item may include one or more of: a job opening; an available contract; an offered service; an offered product; a business establishment; and a piece of content. The multi-level referral program may include: a first referral level; and at least a second referral level. The first referral level may be associated with a first bonus structure and the at least a second referral level may be associated with at least a second bonus structure. The first bonus structure may include one or more of: a first fixed amount; a first percentage; and a first per hour rate. The at least a second bonus structure may include one or more of: at least a second fixed amount; at least a second percentage; and at least a second per hour rate. A user may be enabled to refer the listing for the item to a third party. The third party may include one or more of: a third party directly-interested in the item; and a third party indirectly-interested in the item. Enabling a user to refer the listing for the item to a third party may include enabling the user to refer the listing for the item to the third party via a social media platform. Enabling a user to refer the listing for the item to a third party may include enabling the user to refer the listing for the item to the third party via a messaging platform.

In another implementation, a computer program product resides on a computer readable medium and has a plurality of instructions stored on it. When executed by a processor, the instructions cause the processor to perform operations including: defining a listing for an item; and defining a multi-level referral program for the listing.

One or more of the following features may be included. The item may include one or more of: a job opening; an available contract; an offered service; an offered product; a business establishment; and a piece of content. The multi-level referral program may include: a first referral level; and at least a second referral level. The first referral level may be associated with a first bonus structure and the at least a second referral level may be associated with at least a second bonus structure. The first bonus structure may include one or more of: a first fixed amount; a first percentage; and a first per hour rate. The at least a second bonus structure may include one or more of: at least a second fixed amount; at least a second percentage; and at least a second per hour rate. A user may be enabled to refer the listing for the item to a third party. The third party may include one or more of: a third party directly-interested in the item; and a third party indirectly-interested in the item. Enabling a user to refer the listing for the item to a third party may include enabling the user to refer the listing for the item to the third party via a social media platform. Enabling a user to refer the listing for the item to a third party may include enabling the user to refer the listing for the item to the third party via a messaging platform.

In another implementation, a computing system includes a processor and memory is configured to perform operations including: defining a listing for an item; and defining a multi-level referral program for the listing.

One or more of the following features may be included. The item may include one or more of: a job opening; an available contract; an offered service; an offered product; a business establishment; and a piece of content. The multi-level referral program may include: a first referral level; and at least a second referral level. The first referral level may be associated with a first bonus structure and the at least a second referral level may be associated with at least a second bonus structure. The first bonus structure may include one or more of: a first fixed amount; a first percentage; and a first per hour rate. The at least a second bonus structure may include one or more of: at least a second fixed amount; at least a second percentage; and at least a second per hour rate. A user may be enabled to refer the listing for the item to a third party. The third party may include one or more of: a third party directly-interested in the item; and a third party indirectly-interested in the item. Enabling a user to refer the listing for the item to a third party may include enabling the user to refer the listing for the item to the third party via a social media platform. Enabling a user to refer the listing for the item to a third party may include enabling the user to refer the listing for the item to the third party via a messaging platform.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a referral process according to an embodiment of the present disclosure;

FIG. 2 is a flowchart of an implementation of the referral process of FIG. 1 according to an embodiment of the present disclosure; and

FIGS. 3A-3I are diagrammatic views of interfaces rendered by the referral process of FIG. 1 according to an embodiment of the present disclosure.

Like reference symbols in the various drawings indicate like elements.

### DETAILED DESCRIPTION OF THE PREFERRED EMBODIMENTS

System Overview

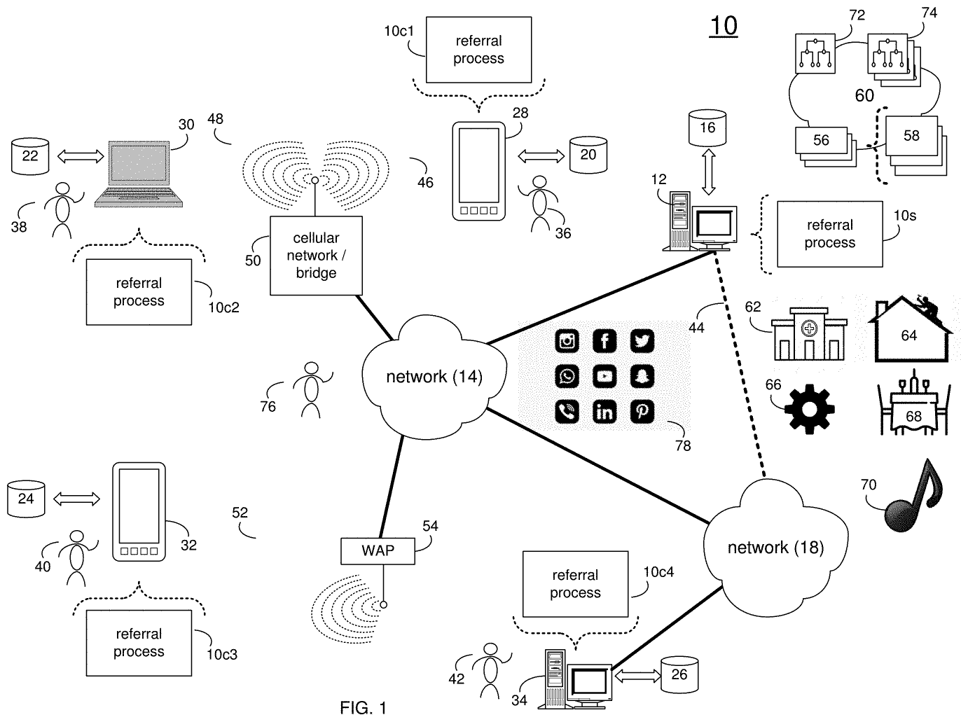

Referring to FIG. 1, there is shown referral process 10. Referral process 10 may be implemented as a server-side process, a client-side process, or a hybrid server-side/client-side process. For example, referral process 10 may be implemented as a purely server-side process via referral process 10s. Alternatively, referral process 10 may be implemented as a purely client-side process via one or more of referral process 10c1, referral process 10c2, referral process 10c3, and referral process 10c4. Alternatively still, referral process 10 may be implemented as a hybrid server-side/client-side process via referral process 10s in combination with one or more of referral process 10c1, referral process 10c2, referral process 10c3, and referral process 10c4. Accordingly, referral process 10 as used in this disclosure may include any combination of referral process 10s, referral process 10c1, referral process 10c2, referral process, and referral process 10c4.

Referral process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of referral process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of referral processes 10c1, 10c2, 10c3, 10c4 may include but are not limited to a client application, a web browser, a game console user interface, or a specialized application (e.g., an application running on e.g., the Android™ platform or the iOS™ platform). The instruction sets and subroutines of referral processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access referral process 10 directly through network 14 or through secondary network 18. Further, referral process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Referral Process

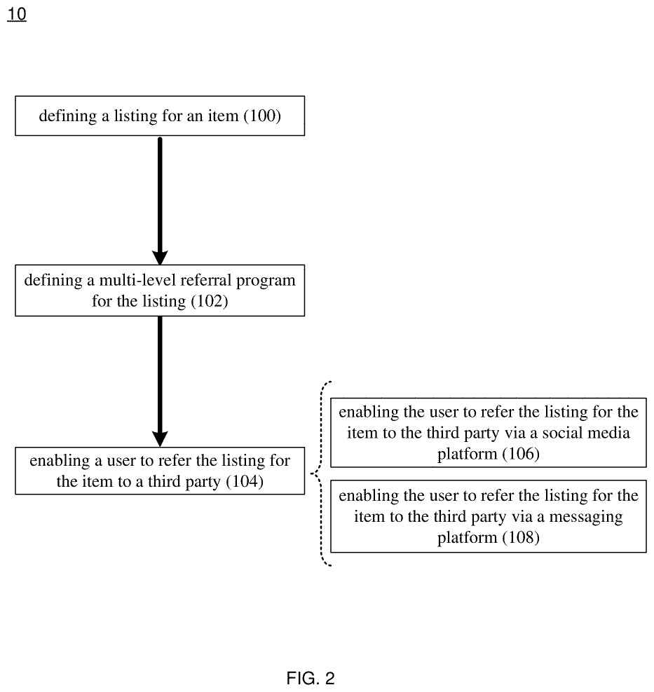

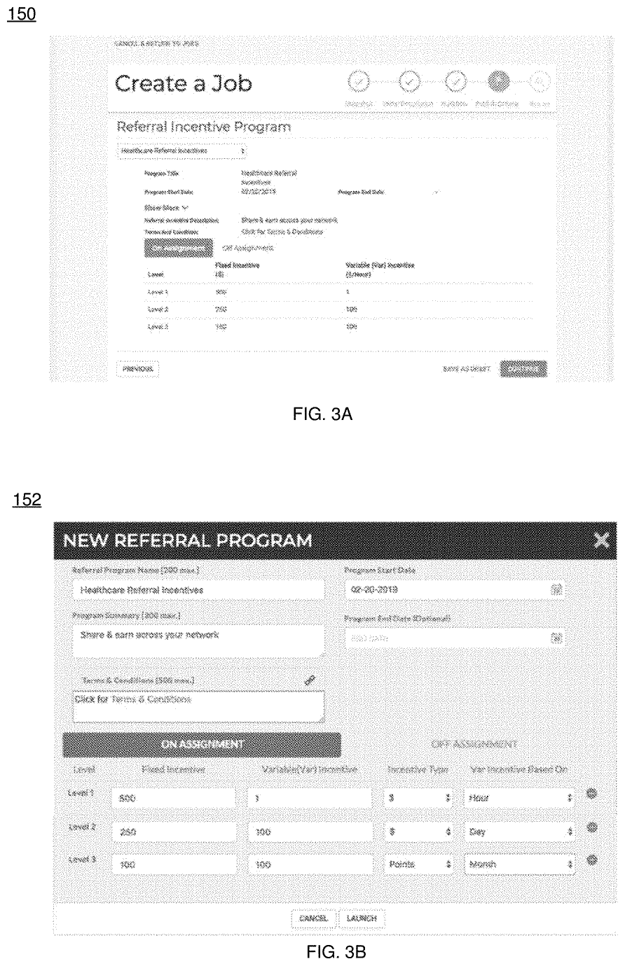

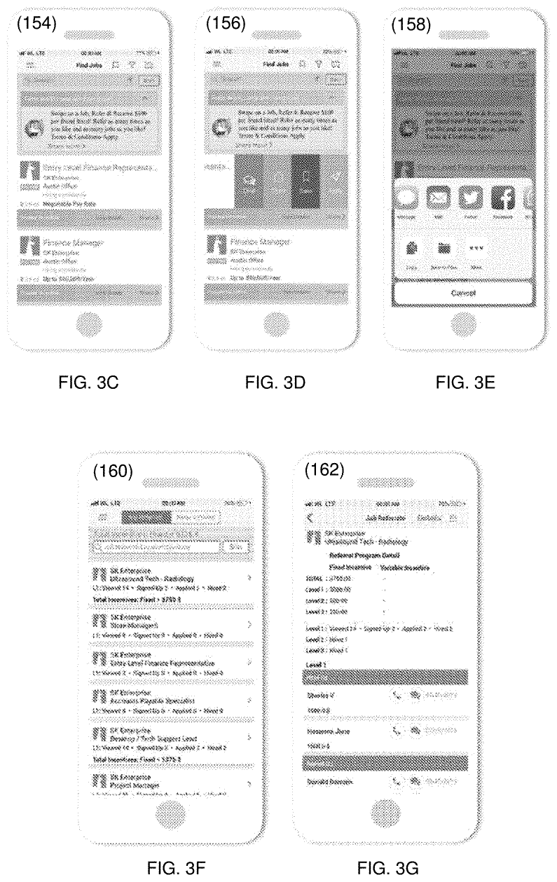

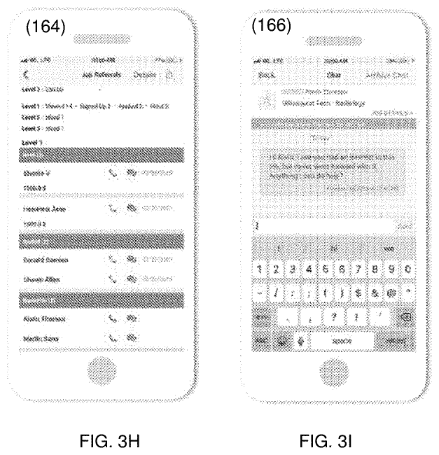

Referring also to FIG. 2 and as will be discussed below in greater detail, referral process 10 may enable a user (e.g., user 42) to define 100 listings (e.g., listings 56) for various items (e.g., items 58), wherein these listings (e.g., listings 56) may be posted to (and made available via) an accessible space (e.g., website 60). Examples of items 58 may include but are not limited to one or more of: a job opening; an available contract; an offered service; an offered product; a business establishment; and a piece of content. Referral process 10 may be configured to enable the user (e.g., user 42) to define 100 a listing (e.g., one of listings 56) for an item (e.g., one of items 58) via e.g., listing creation interface 150 (shown in FIG. 3A).

Therefore, referral process 10 may enable a user (e.g., user 42) to define a listing (e.g., one of listings 56) for a job opening that is available at a company for which user 36 works. For example, assume that user 42 is a hiring manager at hospital 62 and hospital 62 is looking for a permanent surgical nurse. User 42 may define a listing (e.g., one of listings 56) for a surgical nurse position (i.e., permanent) via referral process 10, wherein this listing (e.g., one of listings 56) may be made available via website 60 and may e.g., define the work location for the job opening, define the compensation for the job opening and define the benefits of the job opening.

Additionally/alternatively, referral process 10 may enable a user (e.g., user 42) to define a listing (e.g., one of listings 56) for an available contract. Accordingly, assume that user 42 is again the hiring manager at hospital 62 and hospital 62 is looking for a temporary surgical nurse (e.g., to temporarily replace a permanent surgical nurse that is going to be out on maternity leave for the next three months). User 42 may define a listing (e.g., one of listings 56) for a surgical nurse position (i.e., contract-based for three months) via referral process 10, wherein this listing (e.g., one of listings 56) may be made available via website 60 and may e.g., define the work location for the contract, define the compensation for the contract, define the duration of the contract and define the benefits of the contract.

Additionally/alternatively, referral process 10 may enable a user (e.g., user 42) to define a listing (e.g., one of listings 56) for an offered service. Accordingly, assume that user 42 is general contractor that specializes in roofing and is looking for new work for their business (e.g., business 64). User 42 may define a listing (e.g., one of listings 56) for business 64 via referral process 10, wherein this listing (e.g., one of listings 56) may be made available via website 60 and may e.g., define the experience & expertise of business 64, provide the rates of business 64, provide customer references for business 64, and provide contact information for business 64.

Additionally/alternatively, referral process 10 may enable a user (e.g., user 42) to define a listing (e.g., one of listings 56) for an offered product. Accordingly, assume that user 42 is an entrepreneur who developed a unique widget (e.g., widget 66) that they are offering for sale. User 42 may define a listing (e.g., one of listings 56) for widget 66 via referral process 10, wherein this listing (e.g., one of listings 56) may be made available via website 60 and may e.g., define the specifics of widget 66, provide the price of widget 66, provide customer reviews concerning widget 66, and provide ordering information for widget 66.

Additionally/alternatively, referral process 10 may enable a user (e.g., user 42) to define a listing (e.g., one of listings 56) for a business establishment. Accordingly, assume that user 42 is a chef and is looking for new business for their restaurant (e.g., restaurant 68). User 42 may define a listing (e.g., one of listings 56) for restaurant 68 via referral process 10, wherein this listing (e.g., one of listings 56) may be made available via website 60 and may e.g., define the menu of restaurant 68, define the hours of restaurant 68, provide customer reviews for restaurant 68, and provide the location of restaurant 68.

Additionally/alternatively, referral process 10 may enable a user (e.g., user 42) to define a listing (e.g., one of listings 56) for a piece of content. Accordingly, assume that user 42 is the lead guitarist of a band and is looking to promote their latest album (e.g., content 70). User 42 may define a listing (e.g., one of listings 56) for content 70 via referral process 10, wherein this listing (e.g., one of listings 56) may be made available via website 60 and may e.g., define the musical history of user 42 (and his band), define tour information user 42 (and his band), provide booking information for user 42 (and his band), and provide download and/or purchase information for content 70.

Accordingly and as discussed above, referral process 10 may (e.g., enable a user to) define 100 a listing (e.g., one of listings 56) for an item (e.g., one of items 58). Further, referral process 10 may (e.g., enable a user to) define 102 a multi-level referral program (e.g., multi-level referral program 72) for the listing (e.g., one of listings 56). For example and when defining 102 a multi-level referral program (e.g., multi-level referral program 72) for the listing (e.g., one of listings 56), the user (e.g., user 42) may select a multi-level referral program (e.g., multi-level referral program 72) for the listing (e.g., one of listings 56) from plurality of available multi-level referral programs 74, examples of which may include but are not limited to: a fixed amount multi-level referral program, a percentage-based multi-level referral program and/or a hour-based multi-level referral program. Accordingly and while the following discussion concerns the three above-described referral programs (e.g., fixed amount, percentage-based and hour-based), this is for illustrative purposes only and is not intended to be a limitation of this disclosure, as other multi-level referral programs are possible and are considered to be within the scope of this disclosure.

Referral process 10 may be configured to make recommendations to a user concerning which multi-level referral program (e.g., multi-level referral program 72) to use for a particular listing. For example, storage device 16 may be configured to store data sets (not shown) concerning the various multi-level referral programs available via referral process 10, as well as the success of each of these multi-level referral programs with respect to the different types of items (e.g., job openings versus widgets versus content versus restaurants). Accordingly, referral process 10 may be configured to process such data sets (not shown) using machine learning/artificial intelligence and probabilistic modelling.

When processing such data sets (not shown), referral process 10 may use probabilistic modeling to accomplish such processing, wherein examples of such probabilistic modeling may include but are not limited to discriminative modeling, generative modeling, or combinations thereof.

As is known in the art, probabilistic modeling may be used within modern artificial intelligence systems, in that these probabilistic models may provide artificial intelligence systems with the tools required to autonomously analyze vast quantities of data.

Examples of the tasks for which probabilistic modeling may be utilized may include but are not limited to:
predicting media (music, movies, books) that a user may like or enjoy based upon media that the user has liked or enjoyed in the past;
transcribing words spoken by a user into editable text;
grouping genes into gene clusters;
identifying recurring patterns within vast data sets;
filtering email that is believed to be spam from a user's inbox;
generating clean (i.e., non-noisy) data from a noisy data set;
analyzing (voice-based or text-based) customer feedback; and
diagnosing various medical conditions and diseases.

For each of the above-described applications of probabilistic modeling, an initial probabilistic model may be defined, wherein this initial probabilistic model may be subsequently (e.g., iteratively or continuously) modified and revised, thus allowing the probabilistic models and the artificial intelligence systems (e.g., referral process 10) to “learn” so that future probabilistic models may be more precise and may explain more complex data sets.

Referral process 10 may be configured to allow a user (e.g., user 42) to select an existing multi-level referral program (e.g., multi-level referral program 72) or may allow the user (e.g., user 42) to define a new/custom multi-level referral program via e.g., referral interface 152 shown in FIG. 3B.

Once the above-described listing (e.g., one of listings 56) is defined 100 and multi-level referral program (e.g., multi-level referral program 72) is defined 102, visitors/members/participants of website 60 may be notified that a new listing has been posted on website 60 (thus directing traffic to website 60).

As will be discussed below in greater detail, the multi-level referral program (e.g., multi-level referral program 72) may be configured to encourage visitors of website 60 to refer e.g., one or more of the above-described items (i.e., the above-described permanent job position, the above-described contract job position, the above-described contractor services, the above-described widget, the above-described restaurant and/or the above-described content) to third parties and, in response to making such referrals, the referrer (i.e., the visitor of website) may be compensated.

Accordingly and as will be discussed below in greater detail, referral process 10 may enable 104 a user to refer the listing (e.g., one of listings 56) for an item (e.g., one of items 58) to a third party, wherein this third party may include one or more of a third party that is directly-interested in the item (e.g., one of items 58) and/or a third party that is indirectly-interested in the item (e.g., one of items 58).

For example, referral process 10 may be configured to:
enable the user to search the listings/items defined within website 60 via e.g., searching interface 154 rendered by referral process 10 and shown in FIG. 3C;
enable the user to choose the specific listing(s)/item(s) for referral from those defined within website 60 via e.g., referral selection interface 156 rendered by referral process 10 and shown in FIG. 3D; and
enable the user to select the referral methodology for the specific listing(s)/item(s) being referred via e.g., referral methodology interface 158 rendered by referral process 10 and shown in FIG. 3E.

While the following discussion concerns the referrer (i.e., the visitor of website) being monetarily compensated for making such referrals, it is understood that this is for illustrative purposes only and is not intended to be a limitation of this disclosure, as other configurations are possible and are considered to be within the scope of this disclosure. For example, the referrer (i.e., the visitor of website) may be compensated via hotel points, travel miles, program status, user privileges, etc.

As will be discussed below in greater detail, multi-level referral program 72 may include: a first referral level and at least a second referral level, wherein:
the first referral level may be associated with a first bonus structure (e.g., a first fixed amount, a first percentage and/or a first per hour rate); and
the at least a second referral level may be associated with at least a second bonus structure (e.g., at least a second fixed amount, at least a second percentage and/or at least a second per hour rate).

Fixed Amount:

When a fixed amount multi-level referral program is defined 102 for the listing (e.g., one of listings 56) for an item (e.g., one of items 58), the referrer may be compensated via a flat fee (i.e., a fixed amount) that may vary depending upon the level of the referrer.
For example, assume that user 76 is visiting website 60 and sees a listing (e.g., one of listings 56) for the above-described permanent surgical nurse job position (e.g., one of items 58). Assume that user 76 believes that user 36 is perfect for that position and thinks they may be interested in the same. Accordingly, referral process 10 may enable 104 user 76 to refer the listing (e.g., one of listings 56) for the above-described permanent surgical nurse job position (e.g., one of items 58). In the event that user 36 is e.g., offered and accepts this surgical nurse position:
   i. user 76 may receive e.g., a $1,000 referral bonus (as the direct referrer of user 36).
Further, assume that hospital 62 has an additional opening for a permanent surgical nurse and that user 36 (i.e., the newly-hired surgical nurse) is visiting website 60 and sees the listing (e.g., one of listings 56) for this permanent surgical nurse position (e.g., one of items 58). Assume that user 36 believes that user 38 is perfect for that position and thinks they may be interested in the same. Accordingly, referral process 10 may enable 104 user 36 to refer the listing (e.g., one of listings 56) for the above-described permanent surgical nurse job position (e.g., one of items 58). In the event that user 38 is e.g., offered and accepts this surgical nurse position:
   i. user 36 may receive e.g., a $1,000 referral bonus (as the direct referrer of user 38); and
   ii. user 76 may receive e.g., a $500 referral bonus (as they referred user 36 who referred user 38).
Additionally, assume that hospital 62 has an additional opening for a permanent surgical nurse and that user 38 (i.e., the newly-hired surgical nurse) is visiting website 60 and sees the listing (e.g., one of listings 56) for this permanent surgical nurse position (e.g., one of items 58). Assume that user 38 believes that user 40 is perfect for that position and thinks they may be interested in the same. Accordingly, referral process 10 may enable 104 user 38 to refer the listing (e.g., one of listings 56) for the above-described permanent surgical nurse job position (e.g., one of items 58). In the event that user 40 is e.g., offered and accepts this surgical nurse position:
   i. user 38 may receive e.g., a $1,000 referral bonus (as the direct referrer of user 40);
   ii. user 36 may receive e.g., a $500 referral bonus (as they referred user 38 who referred user 40); and
   iii. user 76 may receive e.g., a $250 referral bonus (as they referred user 36 who referred user 38 who referred user 40).

Naturally, the above-described quantity of levels (i.e., three) and the above-described bonus structure (e.g., $1,000, $500 and $250) is for illustrative purposes only and is not intended to be a limitation of this disclosure, as other configurations are possible and are considered to be within the scope of this disclosure. For example, the number of levels and/or the staging/phasing/size of the bonus structure may be increased and/or decreased depending upon market conditions, business finances, etc.

Fixed Percentage:

When a fixed percentage multi-level referral program is defined 102 for the listing (e.g., one of listings 56) for an item (e.g., one of items 58), the referrer may be compensated via a flat percentage (i.e., a fixed percentage) that may vary depending upon the level of the referrer.
For example, assume that user 76 is visiting website 60 and sees a listing (e.g., one of listings 56) for widget 66 (e.g., one of items 58). Assume that user 76 believes that user 36 may be interested in widget 66. Accordingly, referral process 10 may enable 104 user 76 to refer the listing (e.g., one of listings 56) for widget 66 (e.g., one of items 58). In the event that user 36 e.g., purchases widget 66:
   i. user 76 may receive e.g., 10% of the purchase price that was paid by user 36 for widget 66 (as the direct referrer of user 36).
Further, assume that user 36 is visiting website 60 and sees the listing (e.g., one of listings 56) for widget 66 (e.g., one of items 58) and believes that user 38 may be interested in widget 66. Accordingly, referral process 10 may enable 104 user 36 to refer the listing (e.g., one of listings 56) for widget 66 (e.g., one of items 58). In the event that user 38 e.g., purchases widget 66:
   i. user 36 may receive e.g., 10% of the purchase price that was paid by user 38 for widget 66 (as the direct referrer of user 38); and
   ii. user 76 may receive e.g., 5% of the purchase price that was paid by user 38 for widget 66 (as they referred user 36 who referred user 38).
Additionally, assume that user 38 is visiting website 60 and sees the listing (e.g., one of listings 56) for widget 66 (e.g., one of items 58) and believes that user 40 may be interested in widget 66. Accordingly, referral process 10 may enable 104 user 38 to refer the listing (e.g., one of listings 56) for widget 66 (e.g., one of items 58). In the event that user 40 e.g., purchases widget 66:
   i. user 38 may receive e.g., 10% of the purchase price that was paid by user 40 for widget 66 (as the direct referrer of user 40);
   ii. user 36 may receive e.g., 5% of the purchase price that was paid by user 40 for widget 66 (as they referred user 38 who referred user 40); and
   iii. user 76 may receive e.g., 2.5% of the purchase price that was paid by user 40 for widget 66 (as they referred user 36 who referred user 38 who referred user 40).

Naturally, the above-described quantity of levels (i.e., three) and the above-described bonus structure (e.g., 10%, 5% and 2.5%) is for illustrative purposes only and is not intended to be a limitation of this disclosure, as other configurations are possible and are considered to be within the scope of this disclosure. For example, the number of levels and/or the staging/phasing/size of the bonus structure may be increased and/or decreased depending upon market conditions, business finances, etc.

Per Hour Rate:

When a per hour rate multi-level referral program is defined 102 for the listing (e.g., one of listings 56) for an item (e.g., one of items 58), the referrer may be compensated via a per hour fee (i.e., a per hour rate) that may vary depending upon the level of the referrer.
For example, assume that user 76 is visiting website 60 and sees a listing (e.g., one of listings 56) for the above-described contract-based surgical nurse job position (e.g., one of items 58), wherein this contract-based surgical nurse job position is a 400 hour contract. Assume that user 76 believes that user 36 is perfect for that position and thinks they may be interested in the same. Accordingly, referral process 10 may enable 104 user 76 to refer the listing (e.g., one of listings 56) for the above-described contract-based surgical nurse job position (e.g., one of items 58). In the event that user 36 is e.g., offered and accepts this surgical nurse position:
   i. user 76 may receive e.g., a $10 per hour referral bonus . . . for a total of $4,000 (as the direct referrer of user 36).
Further, assume that hospital 62 has an additional opening for a contract-based surgical nurse and that user 36 (i.e., the newly-hired surgical nurse) is visiting website 60 and sees the listing (e.g., one of listings 56) for this contract-based surgical nurse position (e.g., one of items 58), wherein this contract-based surgical nurse job position is a 200 hour contract. Assume that user 36 believes that user 38 is perfect for that position and thinks they may be interested in the same. Accordingly, referral process 10 may enable 104 user 36 to refer the listing (e.g., one of listings 56) for the above-described contract-based surgical nurse job position (e.g., one of items 58). In the event that user 38 is e.g., offered and accepts this surgical nurse position:
   i. user 36 may receive e.g., a $10 per hour referral bonus . . . for a total of $2,000 (as the direct referrer of user 38); and
   ii. user 76 may receive e.g., a $5 per hour referral bonus . . . for a total of $1,000 (as they referred user 36 who referred user 38).
Additionally, assume that hospital 62 has an additional opening for a contract-based surgical nurse and that user 38 (i.e., the newly-hired surgical nurse) is visiting website 60 and sees the listing (e.g., one of listings 56) for this contract-based surgical nurse position (e.g., one of items 58), wherein this contract-based surgical nurse job position is a 300 hour contract. Assume that user 38 believes that user 40 is perfect for that position and thinks they may be interested in the same. Accordingly, referral process 10 may enable 104 user 38 to refer the listing (e.g., one of listings 56) for the above-described contract-based surgical nurse job position (e.g., one of items 58). In the event that user 40 is e.g., offered and accepts this surgical nurse position:
   i. user 38 may receive e.g., a $10 per hour referral bonus . . . for a total of $3,000 (as the direct referrer of user 40);
   ii. user 36 may receive e.g., a $5 per hour referral bonus . . . for a total of $1,500 (as they referred user 38 who referred user 40); and
   iii. user 76 may receive e.g., a $2.50 per hour referral bonus . . . for a total of $750 (as they referred user 36 who referred user 38 who referred user 40).

Naturally, the above-described quantity of levels (i.e., three) and the above-described bonus structure (e.g., $10 per hour, $5 per hour and $2.50 per hour) is for illustrative purposes only and is not intended to be a limitation of this disclosure, as other configurations are possible and are considered to be within the scope of this disclosure. For example, the number of levels and/or the staging/phasing/size of the bonus structure may be increased and/or decreased depending upon market conditions, business finances, etc.

As discussed above, referral process 10 may enable 104 a user to refer the listing (e.g., one of listings 56) for an item (e.g., one of items 58) to a third party, wherein this third party may include one or more of a third party that is directly-interested in the item (e.g., one of items 58) and/or a third party that is indirectly-interested in the item (e.g., one of items 58).

Examples of a third party that is directly-interested in the item (e.g., one of items 58) may include any of users 36, 38, 40, as these are the parties that (in accordance with the above-described examples) are interested in e.g., the permanent surgical nurse position, widget 66 and/or the contract-based surgical nurse position. Examples of a third party that is indirectly-interested in the item (e.g., one of items 58) may include but are not limited to a recruiter/headhunter (not shown) that may fill vacant job positions, a contractor referral service (not shown) that may connect homeowners and contractors, a social influencer (not shown) that may steer business toward a particular product and/or business, and an agent/promoter (not shown) that may promote music acts.

When enabling 104 a user (e.g., users 76, 36, 38) to refer the listing (e.g., one of listings 56) for an item (e.g., one of items 58) to a third party, referral process 10 may: enable 106 the user (e.g., users 76, 36, 38) to refer the listing (e.g., one of listings 56) for an item (e.g., one of items 58) to the third party via a social media platform (e.g., one or more of platforms 78) and/or enable 108 the user (e.g., users 76, 36, 38) to refer the listing (e.g., one of listings 56) for an item (e.g., one of items 58) to the third party via a messaging platform (e.g., one or more of platforms 78). Examples of platforms 78 may include but are not limited to: Instagram™, Facebook™, Twitter™, a text messaging platform, YouTube™, Snapchat™, an audio messaging platform, LinkedIn™ and Pinterest™.

Referral process 10 may be configured to enable the user to monitor the status of their referrals and stay in contact with the same. For example:
referral summary interface 160 rendered by referral process 10 and shown in FIG. 3F may be configured to enable the user to quickly ascertain the status of their referrals;
referral detail interfaces 162, 164 rendered by referral process 10 and shown in FIG. 3G-3H may be configured to enable the user to view the details of their referrals; and
referral chat interface 166 rendered by referral process 10 and shown in FIG. 31 may be configured to enable the user to chat with their referrals.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising
defining a listing for an item; and
defining a multi-level referral program for the listing.

2. The computer-implemented method of claim 1 wherein the item includes one or more of:
a job opening;
an available contract;
an offered service;
an offered product;
a business establishment; and
a piece of content.

3. The computer-implemented method of claim 1 wherein the multi-level referral program includes:
a first referral level; and
at least a second referral level.

4. The computer-implemented method of claim 3 wherein the first referral level is associated with a first bonus structure and the at least a second referral level is associated with at least a second bonus structure.

5. The computer-implemented method of claim 4 wherein the first bonus structure includes one or more of:
a first fixed amount;
a first percentage; and
a first per hour rate.

6. The computer-implemented method of claim 4 wherein the at least a second bonus structure includes one or more of:
at least a second fixed amount;
at least a second percentage; and
at least a second per hour rate.

7. The computer-implemented method of claim 1 further comprising:
enabling a user to refer the listing for the item to a third party.

8. The computer-implemented method of claim 7 wherein the third party includes one or more of:
a third party directly-interested in the item; and
a third party indirectly-interested in the item.

9. The computer-implemented method of claim 7 wherein enabling a user to refer the listing for the item to a third party includes:
enabling the user to refer the listing for the item to the third party via a social media platform.

10. The computer-implemented method of claim 7 wherein enabling a user to refer the listing for the item to a third party includes:
enabling the user to refer the listing for the item to the third party via a messaging platform.

11. A computer program product residing on a non-transitory computer readable medium having a plurality of instructions stored thereon which, when executed by a processor, cause the processor to perform operations comprising:
defining a listing for an item; and
defining a multi-level referral program for the listing.

12. The computer program product of claim 11 wherein the item includes one or more of:
a job opening;
an available contract;
an offered service;
an offered product;
a business establishment; and
a piece of content.

13. The computer program product of claim 11 wherein the multi-level referral program includes:
a first referral level; and
at least a second referral level.

14. The computer program product of claim 13 wherein the first referral level is associated with a first bonus structure and the at least a second referral level is associated with at least a second bonus structure.

15. The computer program product of claim 14 wherein the first bonus structure includes one or more of:
a first fixed amount;
a first percentage; and
a first per hour rate.

16. The computer program product of claim 14 wherein the at least a second bonus structure includes one or more of:
at least a second fixed amount;
at least a second percentage; and
at least a second per hour rate.

17. The computer program product of claim 11 further comprising:
enabling a user to refer the listing for the item to a third party.

18. The computer program product of claim 17 wherein the third party includes one or more of:
a third party directly-interested in the item; and
a third party indirectly-interested in the item.

19. The computer program product of claim 17 wherein enabling a user to refer the listing for the item to a third party includes:
enabling the user to refer the listing for the item to the third party via a social media platform.

20. The computer program product of claim 17 wherein enabling a user to refer the listing for the item to a third party includes:
enabling the user to refer the listing for the item to the third party via a messaging platform.

21. A computing system including a processor and memory configured to perform operations comprising:
defining a listing for an item; and
defining a multi-level referral program for the listing.

22. The computing system of claim 21 wherein the item includes one or more of:
a job opening;
an available contract;
an offered service;
an offered product;
a business establishment; and
a piece of content.

23. The computing system of claim 21 wherein the multi-level referral program includes:
a first referral level; and
at least a second referral level.

24. The computing system of claim 23 wherein the first referral level is associated with a first bonus structure and the at least a second referral level is associated with at least a second bonus structure.

25. The computing system of claim 24 wherein the first bonus structure includes one or more of:
a first fixed amount;
a first percentage; and
a first per hour rate.

26. The computing system of claim 24 wherein the at least a second bonus structure includes one or more of:
at least a second fixed amount;
at least a second percentage; and
at least a second per hour rate.

27. The computing system of claim 21 further comprising:
enabling a user to refer the listing for the item to a third party.

28. The computing system of claim 27 wherein the third party includes one or more of:
a third party directly-interested in the item; and
a third party indirectly-interested in the item.

29. The computing system of claim 27 wherein enabling a user to refer the listing for the item to a third party includes:
enabling the user to refer the listing for the item to the third party via a social media platform.

30. The computing system of claim 27 wherein enabling a user to refer the listing for the item to a third party includes:
enabling the user to refer the listing for the item to the third party via a messaging platform.
